(19) United States
(12) Patent Application Publication
(10) Pub. No.: US 2010/0043577 A1
(43) Pub. Date: Feb. 25, 2010

(54) Robotic manipulator

(75) Inventor: Mark E. Rosheim, Minneapolis, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Ross-Hime Designs, Inc., Minneapolis, MN (US)

(21) Appl. No.: 12/455,605

(22) Filed: Jun. 4, 2009

Related U.S. Application Data
(60) Provisional application No. 61/130,905, filed on Jun. 4, 2008.

(51) Int. Cl. G01C 19/54

(52) U.S. Cl. 74/5.4

(57) ABSTRACT

A controlled relative motion system having a base support, an output structure and a plurality of securing links each rotatably connected at a first end thereof to a selected one of the base support and the output structure with a circumferential motion pair of those securing links having each member thereof rotatably connected at an opposite second end thereof to that remaining one of the base support and the output structure so as to have the second end of each member rotate in a corresponding rotation plane. These second ends also rotate about a common symmetry rotation axis perpendicular to the rotation planes. In addition, there is a force imparting member that is coupled to a selected coupling one of said first and second ends of a selected one of said circumferential motion pair of securing links, and is capable of directing said coupling end to rotate.

### CROSS-REFERENCE TO RELATED APPLICATION(S)

This application claims the benefit of Provisional Patent Application No. 61/130,905 filed Jun. 4, 2008 for ROBOTIC MANIPULATOR.

### STATEMENT OF GOVERNMENT INTEREST

The U.S. Government has a paid-up license in this invention and the right in limited circumstances to require the patent owner to license others on reasonable terms as provided for by the terms of Contract No. W9113M-07-C-0016 awarded by US Army Space & Missile Defense Command.

### BACKGROUND

Increasing uses of precision directional sensors has increased the need for mechanical manipulators that can point objects, or workpieces, mounted thereon, such as those sensors, accurately and repeatedly anywhere in a desired workspace. Singularities in the dynamics of such manipulators, or loss of a degree of freedom in the workspace, due both to conditions in the physical structure or in control software used in the control system provided therefor, often impede the performance of mechanical manipulators in reaching these goals.

Many uses of these mechanical manipulators require a highly precise but limited range of motion for the manipulator in providing various desired paintings of objects mounted thereon. One such manipulator that has been used for these purposes is provided by gimbals supporting an object for pointing such as a sensor. In the past, such pointing gimbals have had a gimbal ring arrangement driven by a pair of motors. Their use requires providing therewith flexible wiring and/or slip-rings to supply electrical power to the mounted object, and to provide position and rate information to at least one of the drive motors. These slip-rings or other forms of supplying electrical power and communicating information through or around objects rotating relative to each other often results in reliability problems due to mechanical wear, aging through corrosion, and other environmental factors.

In many instances, and in particular, airborne systems such as missiles, it is very advantageous for manipulators used for pointing sensors therein in desired directions to be very compact. Not only do such manipulators need to be compact in mechanical extent but must also manipulate the sensor mounted thereon in a very compact workspace. The sensors themselves may take a relatively large fraction of the work envelope within which they are manipulated. This necessitates a robotic manipulator that has at least portions thereof with a relatively thin cross-section that permits operation in a confined space while at the same time manipulating a relatively bulky sensor. One reason for this limiting of the sensor motion becoming critical is due to the geometry required of the missile nose cone necessary to meet its aerodynamic performance specifications. The nose cone for example may incorporate a hemispherical transparent lens that, as indicated above, requires the motion of the sensor to track the geometry of the interior surface of that lens at a constant small separation distance such that the sensor pointing or sensing axis being maintained in directions normal to that surface.

Another performance requirement is that the mounted object such as a sensor be isolated from shock and vibration. Such mechanical disturbances are always present in uses of such manipulators such as when a missile, in which a sensor is mounted on one of those manipulators, is being handled, carried on a moving platform, or propelled in flight. Elaborate and costly means have been designed for gimbal mounted sensors to isolate them from shock and vibration transmitted thereto by the gimbals. However, this adds to the cost and complexity of the device. Thus, there is a desire for an improved pointing mechanical manipulator especially for use requiring precise direction positioning.

### SUMMARY

The present invention provides controlled relative motion system permitting a controlled motion member, joined to a base member, to selectively move with respect to said base member having a base support, an output structure and a plurality of securing links each rotatably connected at a first end thereof to a selected one of the base support and the output structure so as to be free to rotate about a corresponding intersection rotation axis that intersects that end, and with a circumferential motion pair of those securing links having each member thereof rotatably connected at an opposite second end thereof to that remaining one of the base support and the output structure so as to have the second end of each member rotate in a corresponding rotation plane, all of which rotation planes are parallel to one another, and also so as to rotate about a common symmetry rotation axis perpendicular to the rotation planes that is free of intersecting with any of the second ends. In addition, there is a force imparting member that is coupled to a selected coupling one of said first and second ends of a selected one of said circumferential motion pair of securing links, and is capable of directing said coupling end to rotate.

### BRIEF DESCRIPTION OF THE DRAWINGS

FIG. 1 is an overhead perspective view of a positioning manipulator embodying the present invention,

FIG. 2 is a side perspective view of the manipulator of FIG. 1 tilted,

FIG. 3 is a top view of the manipulator of FIG. 1,

FIG. 4 is a cross section view of the manipulator of FIG. 1,

FIG. 5 is an overhead perspective view of an alternative embodiment of the positioning manipulator of the present invention,

FIG. 6 is another overhead perspective view of the manipulator of FIG. 5, tilted, from a different side,

FIG. 7 is a top view of the manipulator of FIG. 5,

FIG. 8 is a cross section view of the manipulator of FIG. 5,

FIG. 9 is an overhead perspective view of a further alternative embodiment of the positioning manipulator of the present invention,

FIG. 10 is another overhead perspective view of the manipulator of FIG. 9, tilted, from a different side,

FIG. 11 is a top view of the manipulator of FIG. 9,

FIG. 12 is a bottom view of the manipulator of FIG. 9,

FIG. 13 is an isometric view of the manipulator of FIG. 9 tilted,

FIG. 14 is an isometric view of the manipulator of FIG. 9 tilted,

FIG. 15 is a top view of the manipulator of FIG. 9, and

FIG. 16 is a cross section view of the manipulator of FIG. 15,

FIG. 17 is another top view of the manipulator of FIG. 9,

FIG. 18 is a cross section view of the manipulator of FIG. 17.

### DETAILED DESCRIPTION

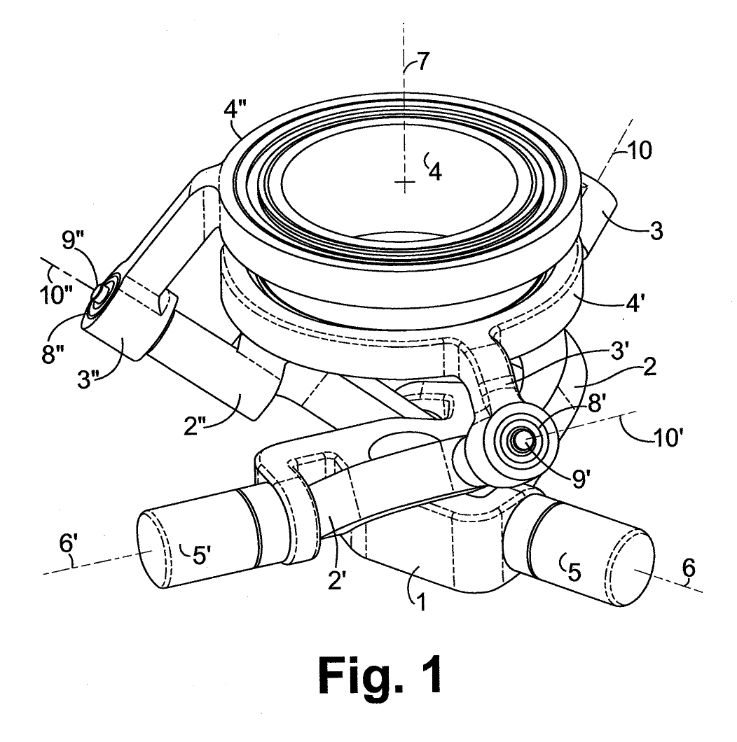

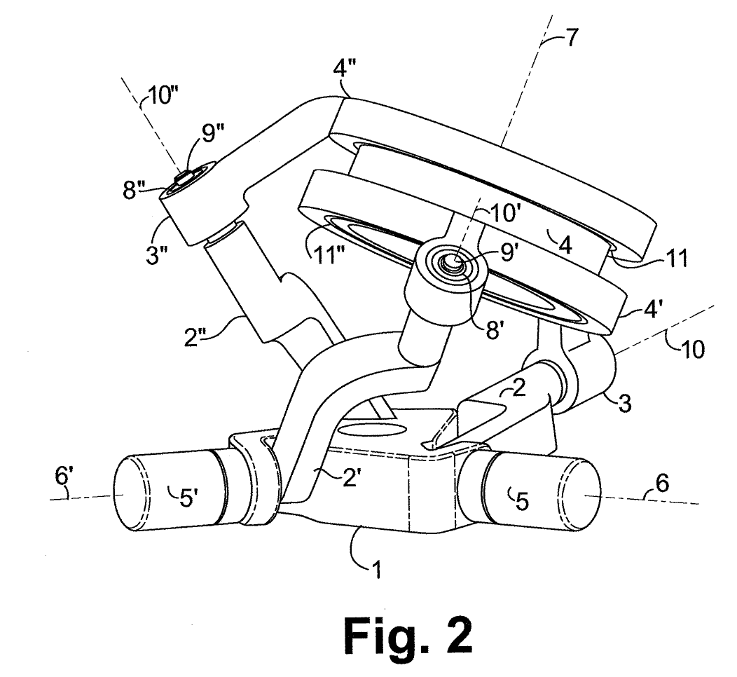

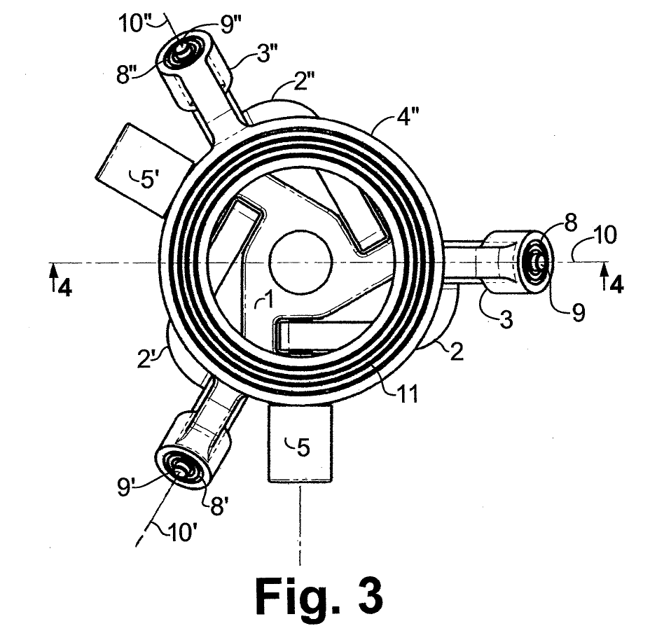

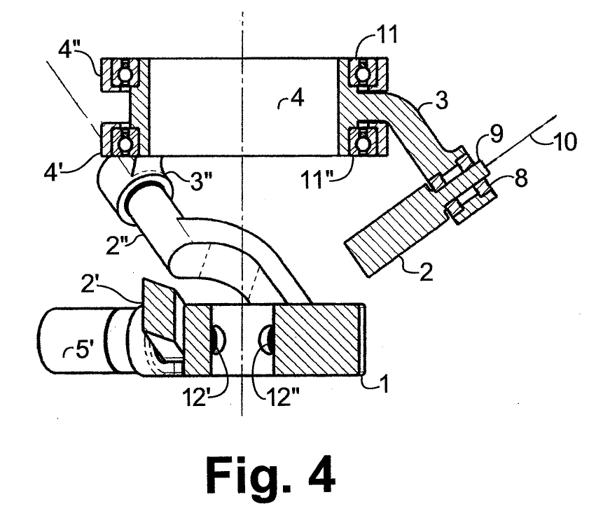

The object positioning arrangement of the present invention, shown in an overhead perspective view in FIG. 1, a side perspective view in FIG. 2, a top view in FIG. 3 and a cross section view in FIG. 4, allows a selected object or workpiece mounted in a manipulator to be rotated to various alternative spatial orientations, or directional pointings, about a single center point of rotation. As shown in these figures, a base member, 1, is rotatably engaged with three links, 2, 2′ and 2″, which are each rotatably connected to one end of a corresponding one of three arms, 3, 3′ and 3″. Each of arms 3, 3′ and 3″ is affixed through an angled bar at its other end to a corresponding one of a truncated cylindrical shell, 4, and two ring members, 4′ and 4″, each surrounding a corresponding portion of that cylindrical shell.

These two ring members and the truncated shell cooperate in various movements resulting from the applied forces of two motors, 5 and 5′, mounted on base 1, that force the corresponding ones of links 2 and 2′, respectively, to which they are connected to rotate in base 1 about their corresponding rotation axes, 6 and 6′. Such rotations force the remaining link 2″ to also rotate about its rotation axis, 6″, because of the resulting motions of truncated cylindrical shell 4 and ring members 4′ and 4″ even though this remaining link is not connected to any motor. Truncated cylindrical shell 4 and ring members 4′ and 4″are all aligned so as to each have its radial axis of symmetry occur along a common symmetry axis, 7, to thereby result in each such axis being oriented in common with those axes of the others.

These components thus cooperate under applied forces of motors 5 and 5′ to produce motion of the truncated shell and the rings in three-dimensional space about one center point to thereby point symmetry axis 7 in the direction desired. This center point, or the center of rotation, is located at the intersection of the three link rotation axes 6, 6′ and 6″ in base 1 about each of which a corresponding one of links 2, 2′ and 2″ is capable of rotating through its being rotatably connected to base 1 as indicated above.

The three links 2, 2′ and 2″ are each connected at one end to base 1 through a corresponding clevis-like arm in base 1 by a corresponding motor shaft or pin extending through a corresponding one of three pairs of rotatable bearings (only partially shown). Links 2, 2′ and 2″, at their other ends, are connected into a corresponding one of three bearings, 8, 8′ and 8″, each set in a corresponding one of arms 3, 3′ and 3″, by corresponding one of three pivot stem shafts, 9, 9′ and 9″, each extending from one of these link ends into a corresponding one of those bearings. That is, each of links 2, 2′ and 2″ is rotatably connected to a corresponding one of arms 3, 3′ and 3″ through a corresponding one of three pivot pins 9, 9′ and 9″ at the ends thereof that are positioned in a corresponding one of three bearings 8, 8′ and 8″ so as to each be capable of rotating in its bearing about a corresponding axis of rotation, 10, 10′ and 10″. Arms 3, 3′ and 3″ merge into truncated cylindrical shell 4 and rings 4′ and 4″, respectively, with this shell and rings each being capable of rotating about symmetry axis 7 as indicated above.

Rings 4′ and 4″ are mounted around the outer surface of truncated cylindrical shell 4 each near a corresponding end of that shell, and are capable of being rotated about that shell through these mountings being provided by a corresponding one of a pair of thin cross-section ring bearings, 11 and 11′. These thin cross-section bearings are constructed to withstand the static and dynamic forces encountered during use of the manipulator by the very small ball bearings and bearing races needed in such a construction which are ideal for many circumstances in which manipulator configuration space is very limited. Truncated cylindrical shell 4, inside rings 4′ and 4″, forms the manipulator output structure for the mounting therein of any of various objects desired to have a selected directional orientability during use such as a sensor or other workpiece. Thus, such a workpiece is supported in shell 4 by arm 3 as shown in FIG. 4.

Thus, a workpiece is mounted above the center point of rotation at the intersection of the three link rotation axes 6, 6′ and 6″ in base 1 on or in the open interior of shell or output structure 4, or both. Alternatively, output structure 4 and such a workpiece may be to some extent structurally integrated through having some shared structural members.

This configuration is advantageous when manipulating a workpiece, such as a sensor, which, when placed in motion by the manipulator, must follow closely the interior surface of a lens or radome provided thereabout while requiring short lengths of wire, tubing, or fiber optic harnesses for conveying power and signals to or from that workpiece, or both. Also, the workpiece, again such as a sensor, may need to undergo those motions in a very compact workspace without mechanically interfering with its housing or other structures positioned in the vicinity thereof.

In further detail, FIGS. 1 through 3 show motors 5 and 5′ (along with motor 5′ being also shown in FIG. 4) each mounted fixedly to the base member 1. This fixed mounting of these motors to base 1 is highly desirable as any significant motion relative to the base or to each other would necessitate slip rings, flexible wiring or other means to allow such relative motion. In addition, any such movement of these motors would result in their wiring being subjected to potential abrasion, snagging, cutting, fatigue, or other form of undesirable damage that could degrade the performance of the motors.

Motors 5 and 5′ have their rotor output shafts connected to links 2 and 2′ which links have those motor shafts extending therethrough to be held on either side of the link in a corresponding pair of bearings, 12 and 12′, (only partially shown) in the clevis-like arm structures that are part of base 1 as seen in FIGS. 1 through 4. Links 2 and 2′ transmit rotary motions, selected through the rotary forcings provided by the selected operation of motors 5 and 5′, to the upper arms 3′ and 3″ through bearings 8′ and 8″ to produce selective motion of the mounting surface or surfaces in truncated cylindrical shell, or output structure, 4. As can be seen in FIG. 2, the selective rotating of the arms 2 and 2′ forced by the selective operation of motors 5 and 5′ will result in the mounting surface or surfaces of truncated cylindrical shell 4 being manipulated, or tilted, to any of a large range of angular positions. Thus, selected counter-clockwise rotations of the output shafts of motors 5 and 5′ will thereby similarly rotate links 2 and 2′ to result in the far end portions of these two links ascending within the allowed range of rotary motion, and clockwise rotations of those shafts will cause these links to descend.

For example, if ascents occur in selected combinations of such rotations, the end portions of the links furthest from the motors will resultingly move upward and perhaps closer together as permitted by corresponding rotations of rings 4′ and 4″ about large ring bearings 11 and 11′ on shell 4 on which these rings are mounted. Similarly, if link 2″ is forced to ascend or descend because of rotations of the two motors resulting in movements of shell 4, link 2″ may converge toward or diverge away from the two motor rotated links 2 and 2′ depending on the motions selected to be imparted to the two motor driven links.

Links 2, 2′ and 2″, in addition to orienting a workpiece mounted in shell or output structure 4, can be arranged to aid in isolating that workpiece, typically some kind of a sensor, from shock and vibration which may otherwise be transmitted thereto from base 1 of the manipulator. Thus, the arrangements for base bearings 12, 12′ and 12″, link-arm bearings 8, 8′ and 8″, and large shell ring bearings 11 and 11′, in this system may be shock mounted in rubber bushings or provided with other forms of shock and vibration dampening devices.

The mechanical manipulator described above for manipulating the angular position in three-dimensional space of any object mounted in the output structure thereof has the advantage of a large passage, or pass-through opening, extending through truncated cylindrical shell, or output structure 4, and rings 4′ and 4″, and a corresponding opening extending through base 1. This pass-through opening, or passageway, accommodates any wires, fiber optics cables, or any flexible tubes or hoses needed or desirable for use with workpieces mounted in or on shell, or output structure, 4. In addition, as indicated above, mounting motors 5 and 5′ fixedly in base 1 to eliminate the need for flexible wires, cables, commutators, slip rings or twist capsules for the motors to thereby minimize electrical noise and increase reliability.

This manipulator is mechanically stiffened and made more precise in directional pointing through the use of the relatively simple mechanical design therefor that needs relatively few components. The larger available space remaining in a specified manipulator configuration space resulting from this use of the above manipulator with fewer components, and the unique kinematics of that manipulator, allows having the structure thereof further stiffened by increasing the mechanical size of some of those components. This manipulator also can be fabricated with many off-the-shelf components, such as the bearings, to thereby reduce fabrication costs.

A mechanically stiffer object positioning arrangement, such as that described above, allows directional orienting, or pointing, of a workpiece mounted therein to be more precise. Pointing precision can be described as a combination of pointing accuracy and pointing position repeatability. Mechanical stiffness determines the capability for the arrangement to maintain the configuration of component relationships therein for a given output position command so that the workpiece mounted in the stiffened manipulator output structure will come correspondingly closer to the same output position the next time that the command is repeated than it would if instead it was less stiff.

However, selective use of somewhat pliable dampening devices in critical locations, such as use of rubber bushings and other forms of rubber mounts, does not necessarily detract from obtaining better mechanical stiffness. Thus, component mountings and joints can be provided with energy dampening structures that attenuate mechanical shocks or vibrations over time without overly affecting the precision of their positional placements. Compliance can be further managed in actively controlled object positioning arrangement systems where output structure mounted workpieces, such as sensors, are manipulated into various positions for scanning over selected angular ranges in real-time by such a control system in which arrangements often repeatability rather than accuracy is the more important performance specification. A certain amount of sag of the workpiece, or sensor, caused by the distortion of the above mentioned dampening devices, may be tolerated as the servo control loop implemented about the manipulator in such a control system is updated by actual real-time information gathered in connection with the sensor while it is being manipulated to differing orientations.

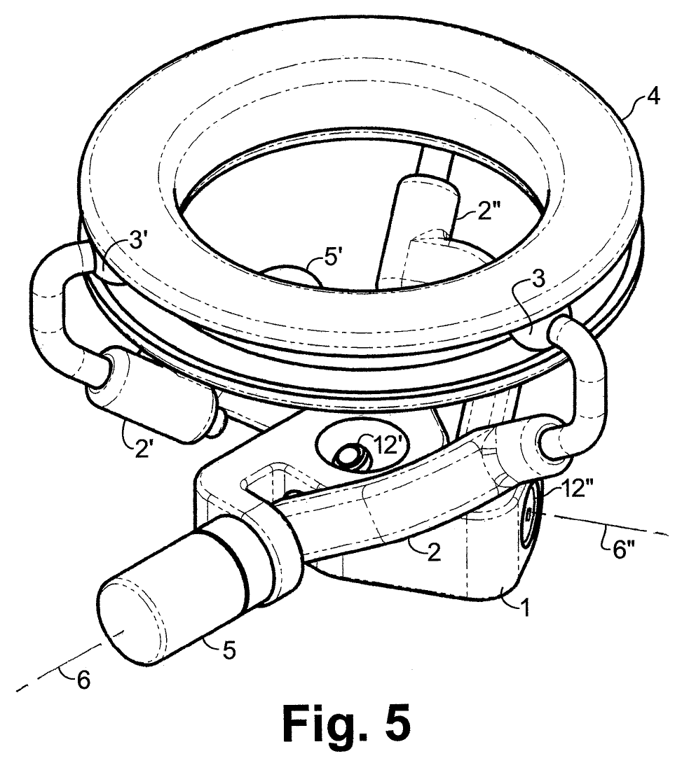

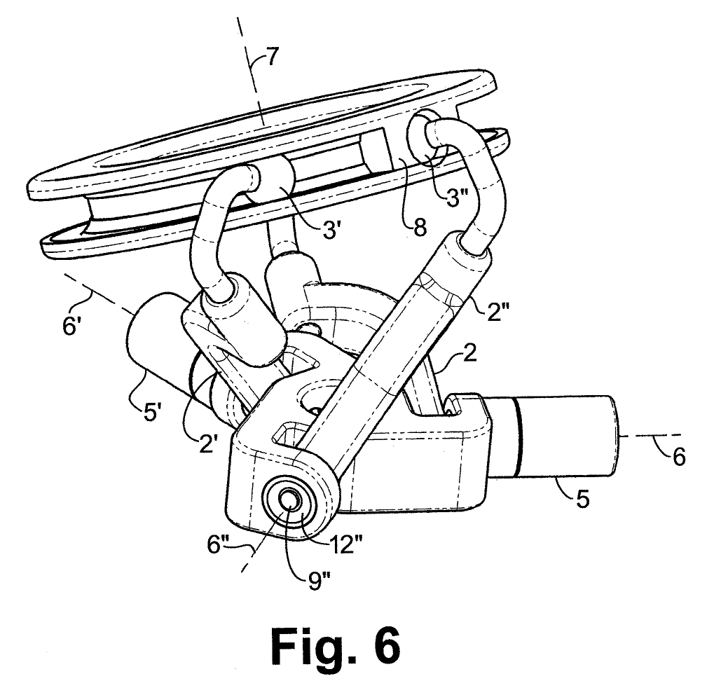

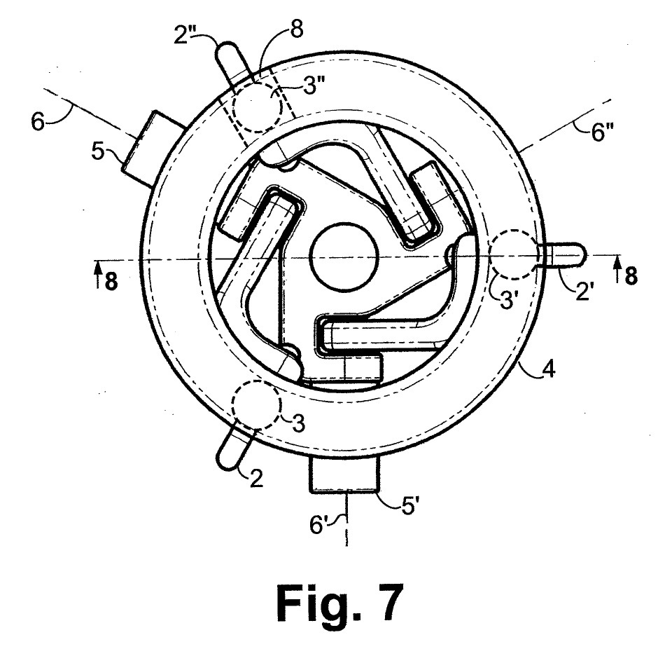

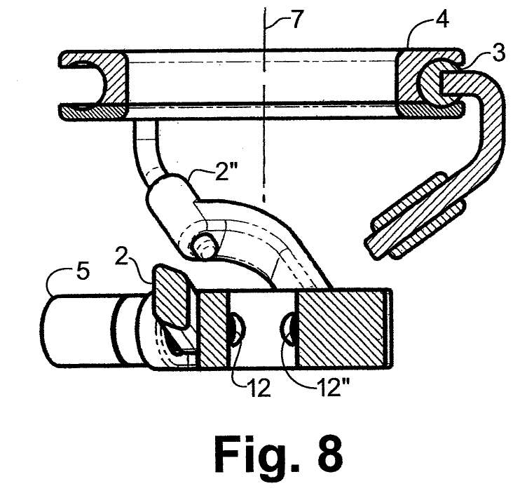

A second embodiment of the object positioning arrangement of the present invention, which uses simpler and less costly components, is shown in an overhead perspective view in FIG. 5, in another overhead perspective view in FIG. 6 from another side, in a top view in FIG. 7, and in a cross section view in FIG. 8. The pair of thin cross-section ring bearings 11 and 11′ as well as the bearings 8, 8′ and 8″ mounted in the arms 3, 3′ and 3″ that were used in the previous embodiment are here eliminated. Base member 1 is used again with three bearing pairs 12, 12′ and 12″ (only partially shown) mounted in its clevis-like arms. Links 2, 2′ and 2″ at one end thereof are rotatably supported by these bearing pairs in base 1 as before. The other ends of these links merge into bent-wire, hook-shaped arms that each terminate in a corresponding one of three bearing members 3, 3′ and 3″. The bearing members 3, 3′ and 3″ are spherical balls affixed to the corresponding ends of those bent-wire, hook-shaped arms, and are also constrained to move in a circular race, or circular groove, machined or otherwise formed into a ring assembly, or output structure, 4. The race has a lip or retaining ring that captures bearing members 3, 3′ and 3″ while still allowing two of them, 3 and 3″, to slide and rotate in the race as best shown in FIG. 8 with bearing 3′ remaining allowed to just rotate in this race at a otherwise fixed position.

Ring assembly 4 may be molded or machined from a polymer material such as Teflon or other self-lubricated plastic. This assembly could also be fabricated from aluminum or any other metal using any variety of machine tools from engine lathes to multi-axis numerically controlled machining centers.

The ring may be provided in two sections as shown in FIG. 8 with the lower circumferential section or portion having only a small part of the circumferential ball retaining groove. The two ring sections could be attached together by any number of fastening or bonding methods such as threading the two split ring sections together, utilizing a radial array of machine screws or self-tapping screws, glues or adhesives, welding or other methods used to join two material structures together.

Also, the split ring portions of ring assembly 4 can be provided with a preloading force against each other thereby creating a preloading force on the spherical ball bearing members 3, 3′ and 3″ to thereby reduce or eliminate backlash. A “wave”, or Belleville, washer mounted between the two ring sections is one method to create a preload and reduce or eliminate backlash. This could be accomplished by forming the groove resulting from the two ring sections being mated together being somewhat smaller than ball members 3, 3′ and 3″ that move in and along that groove. Another method would be to have a radial array of machine screws that could be tightened to tighten together the two ring sections to increase the pressure on the bearing members thus reducing or eliminating unwanted backlash.

As indicated above, spherical ball bearing member 3′ is captured at a fixed location along the circumference of the bearing race in ring assembly 4, and this capture is made by a socket, 8, as a ball and socket or universal joint as seen in FIGS. 6 and 7. Thus, member 3′ can only rotate in the race groove while being constrained to remain at the socket 8 location in the groove. The purpose of rotatably retaining this member is to prevent the undesired rotation of ring assembly 4 about axis 7. Rotation of socket 8, and so of ring assembly 4, about spherical ball bearing member 3′ will occur simply as a byproduct of the selective forced rotations of links 2 and 2′ by motors 5 and 5′, respectively, resulting in forced movements of ring assembly 4, and then also of link 2″. Remaining bearing members 3 and 3″ are constrained in relative motion by the circular groove formed in ring assembly 4 as the race for the motions of those members. The two relatively free bearing members selectively advance toward or retract away from each other depending on the rotations of links 2 and 2′ which are selected by causing rotations of the output shafts of motors 5 and 5′.

The outer side of ring assembly, or output structure, 4, away from base 1, is the mounting surface for any workpiece, such as a sensor, to be manipulated. An advantage of this construction is relatively large objects may be placed on or in this ring assembly, or both, utilizing the space below the inner surface of ring assembly 4, more or less facing base 1, so that the workpiece can extend to or below the plane of this ring inner surface towards base 1. This space in and below ring assembly 4 is larger than in the previous embodiment as it obviates the large ring bearings 4 and 4′ as well as the small bearings 8, 8′ and 8″ mounted in the arms 3, 3′ and 3″ used in that previous embodiment. Rotation of the object to be manipulated again occurs about the center of rotation point formed by the intersection of axes 6, 6′ and 6″ about which links 2, 2′ and 2″ rotate in being rotatably connected through bearing pairs 12, 12′ and 12″ to base 1.

Links 2, 2′ and 2″ can again be arranged to aid in isolating a workpiece, such as a sensor, from shock and vibration which may otherwise be transmitted from base 1 of the manipulator in addition to orienting it as desired. Thus, the arrangements for spherical ball bearing members 3, 3′ and 3″ and link bearings 12, 12′ and 12″ in this system may by shock mounted in rubber bushings or other forms of shock and vibration dampening devices to isolate the workpiece, such as a sensor, from unwanted shock and vibration which could degrade the performance thereof.

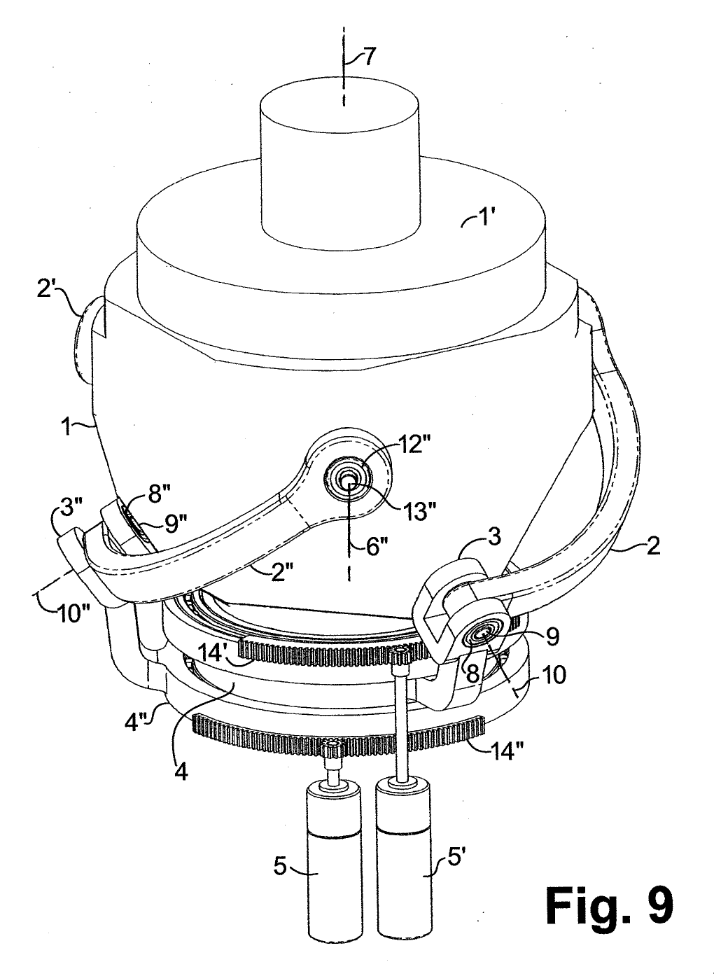

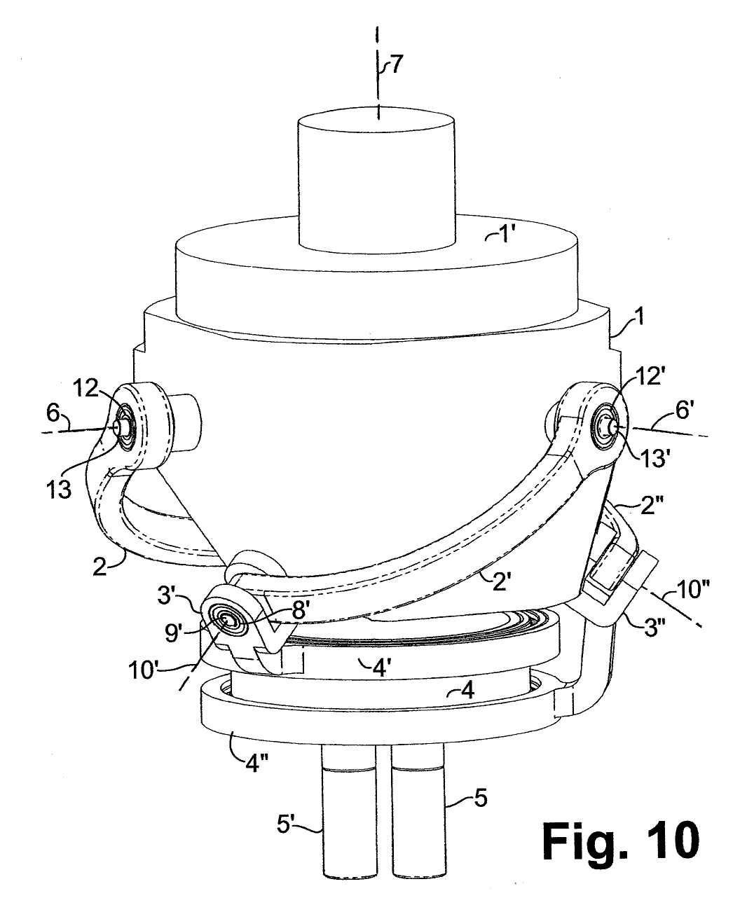

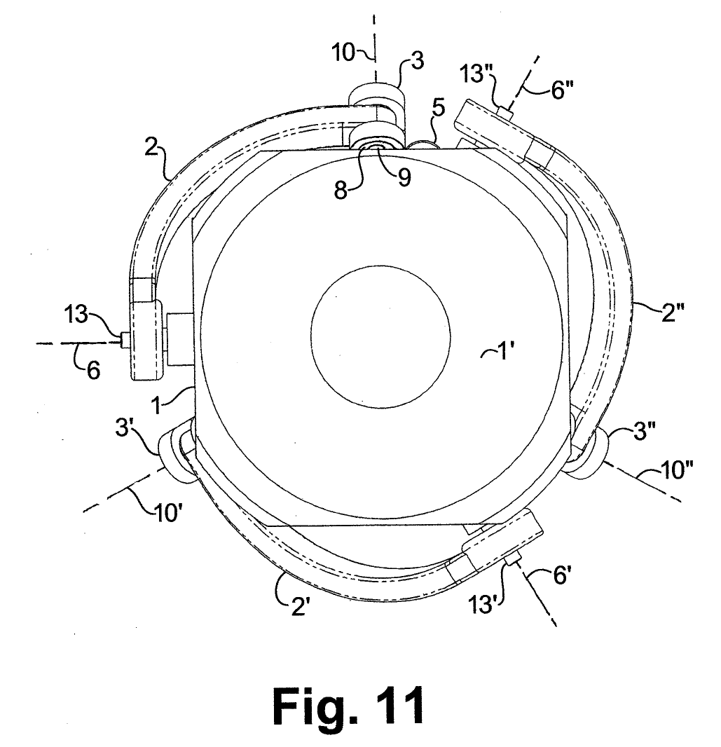

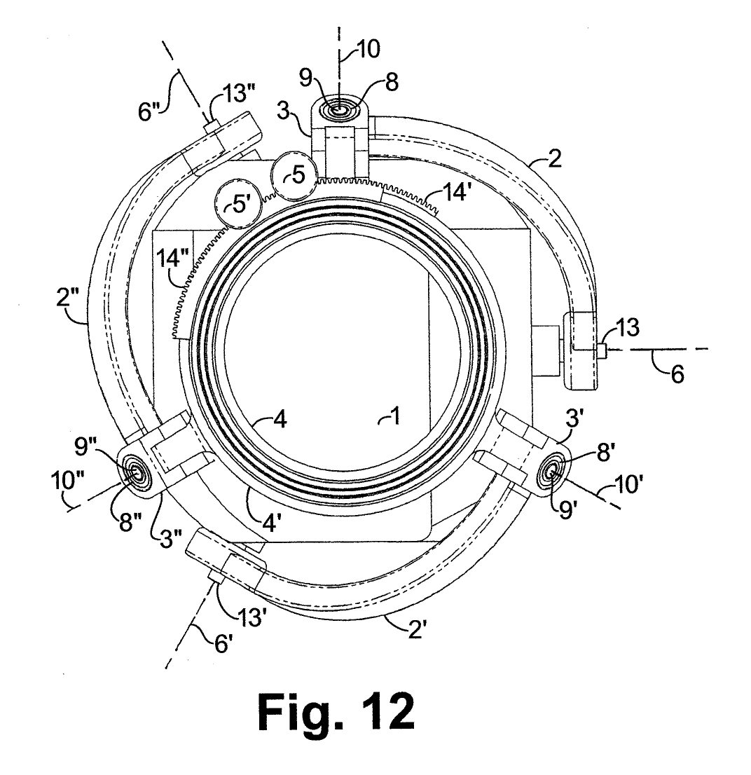

FIGS. 9 through 18 show a third embodiment of the object positioning arrangement of the present invention. The positioning manipulator therein allows for manipulating any object mounted thereon about a single center of rotation point as in the previous embodiments. In this embodiment, however, the center of rotation point is located away from the base rather than in the base as in the previous embodiments. This manipulator is similar to that of the first embodiment in an inverse sense in having the driven components therein occurring in reverse order outward from the driving motors. FIGS. 9 and 10 are overhead perspective views from differing sides of the positioning manipulator, and FIGS. 11 and 12 are top and bottom views thereof, respectively.

Thus, the structure in the present embodiment, which is most similar to base 1 in the first embodiment shown in FIG. 1, is now in FIG. 9 farthest from the motors, and is here the output structure that directly supports a workpiece, such as a sensor, that is to be manipulated to point in desired directions. The links and arms of the first embodiment, extending from the base there to the rings and ring bearings about the truncated cylindrical shell output structure there, here, in the present embodiment, consequently, extend from the present output structure (which is most comparable to the base in the first embodiment) toward the truncated cylindrical shell, and the rings and ring bearings thereabout, serving as part of the base here (which is most comparable to the output structure in the first embodiment) to be in accord with this inverse arrangement pattern indicated above. The actuation motors are used to actuate the present base (which, again, is most comparable to the output structure in the first embodiment).

This arrangement allows placing an object or workpiece to be rotated to various orientations, or directional paintings, by the manipulator through rotating it about a single center point of rotation that is often coincident with the approximate center of the output structure. The workpiece, such as a sensor, will be similarly rotated especially if that workpiece is mounted to the output structure so as to be within an open interior selected to be provided in that structure. Thus, an output structure, 1, can have a workpiece, 1′, depending on its size, mounted above, across from, or even below the center point of rotation in the open interior of output structure 1.

As shown in FIGS. 9 and 10, three links, 2, 2′ and 2″, are rotatably connected output structure 1, shown with workpiece 1′ supported therein. Each link is rotatably connected to a corresponding one of three devises 3, 3′ and 3″ each supported on an angled bar extending from a corresponding one of a truncated cylindrical shell, 4, and a pair of rings, 4′ and 4″. These rings each surround, and are rotatably connected to, shell 4 near an end thereof opposite that of the other, again in a coaxial arrangement based on the axes of symmetry of shell 4 and rings 4′ and 4″ being common to one another. This shell and these rings together provide part of the base of the manipulator in these figures. Thus, the basic manipulator component sequence here is in a sense the inverse of that for the manipulator of the first embodiment as indicated above. A pair of motors, 5 and 5′, is again used to selectively move the manipulator but here, in FIGS. 9 and 10, they are coupled to rings 4′ and 4″ to rotate them rather being coupled to links 2 and 2′ to rotate them as they were in the first embodiment shown in FIG. 1.

The center point of rotation of output structure 1 is the intersection of three axes, 6, 6′ and 6″, about which links 2, 2′ and 2″ rotate to position, or orient, or directionally point, a symmetry axis, 7, perpendicular to axes 6, 6′ and 6″ and passing through their common intersection. This rotation center location is in contrast to the two previous embodiments in FIGS. 1 and 5 in which the mounted object, or workpiece, rotates principally about a center of rotation located in the base structures thereof. This arrangement with rotation center location in output structure 1 is particularly advantageous when manipulating an object, or workpiece, such as a sensor, which, when placed in motion for positioning by the manipulator, must follow closely the interior surface of a lens or radome while requiring relatively short lengths of operation support wiring, tubing, or fiber optic harnessing. Also, the compact circular sector shape of the links about the sensor is advantageous as that sensor may need to undergo these positioning motions in a very compact workspace without mechanically interfering with housings or other structures in the vicinity thereof.

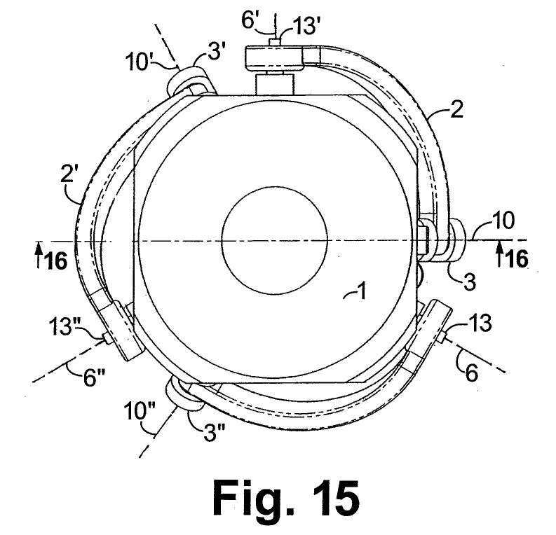

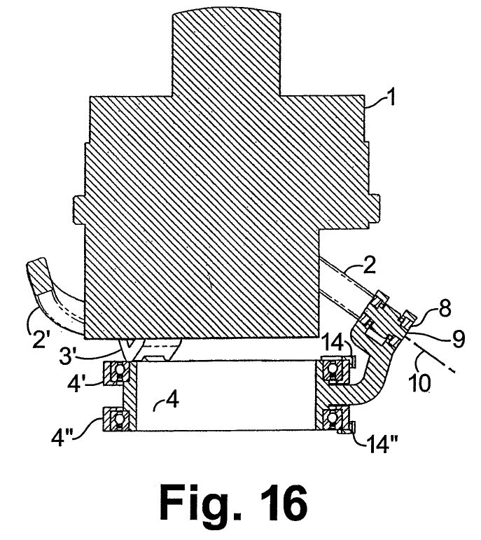

In more detail, as shown in FIGS. 9 and 10, devises 3, 3′ and 3″ each have a corresponding one of three pairs of bearings, 8, 8′ and 8″, therein. These bearing pairs provide rotatable connection to ends of links 2, 2′ and 2″ by having a corresponding one of three pivot pins, 9, 9′ and 9″, each extend through a corresponding end of one of those links into the corresponding bearing pair so that each link is capable of rotating in its bearing pair about a corresponding axis of rotation, 10, 10′ and 10″. Clevises 3, 3′ and 3″ are each supported on an angled bar extending from a corresponding one of truncated cylindrical shell 4 and a pair of rings 4′ and 4″, and these rings each surround, and are rotatably connected to, shell 4 near a corresponding end thereof by a corresponding one of a pair ring bearings, 11 and 11′. This can best be seen in cross section side views provided in FIGS. 15 and 16.

The other ends of links 2, 2′ and 2″ have a corresponding one of three bearings, 12, 12′ and 12″, provided therein for providing a rotatable connection to output structure 1 (and so to workpiece 1′ mounted therein). Output structure 1 has three pivot pins, 13, 13′ and 13″, extending outward from the side wall thereof at symmetrical locations around that wall. The rotatable connections between these links and the output structure is provided by having each of pivot pins 13, 13′ and 13″ positioned in a corresponding one of bearings 12, 12′ and 12″ to thereby allow each link to rotate about a corresponding axis of rotation 6, 6′ and 6″ best seen in FIGS. 11 and 12.

A pair of spur gear sectors, 14′ and 14″, are each affixed to a corresponding one of rings 4′ and 4″, respectively, which rings are, as indicated above, each rotatably mounted by a corresponding one of ring bearings 11 and 11′ to an end of truncated cylindrical shell 4. Motors 5 and 5′, for selectively move the manipulator output structure 1, each has its rotors shaft provided with an extension shaft with a spur pinion gear affixed to the opposite end thereof. Each of these spur pinion gears is engaged with a corresponding one of spur gear sectors 14′ and 14″ to allow motor 5 to force ring 4″ to selectively rotate and to allow motor 5′ to force ring 4′ to selectively rotate.

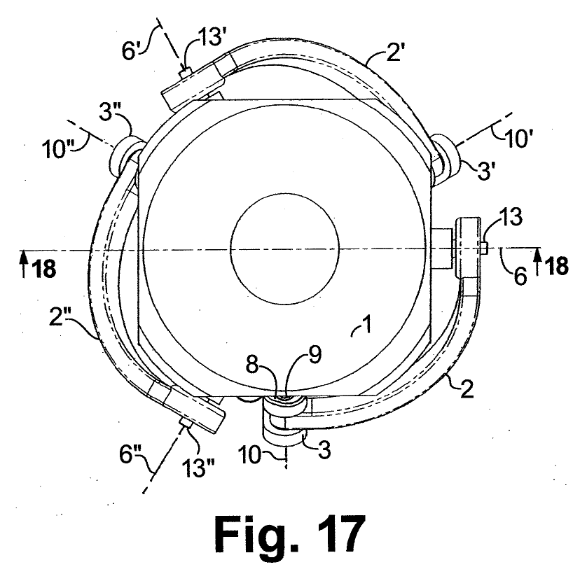

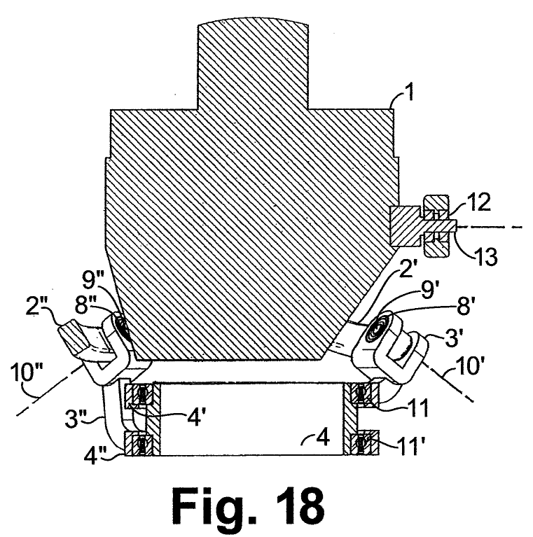

FIG. 15 shows a top view of the third embodiment with a section line designated 16 corresponding to the side cross section view shown in FIG. 16. FIG. 17 shows another top view of the third embodiment with a section line designated 18 corresponding to the side cross section view shown in FIG. 18.

In operation, the motors 5 and 5′ selectively force rotation of sector gears 14′ and 14″ through rotating their motor shafts and the pinion gears thereon thereby causing rotation of rings 4′ and 4″ relative to each other about base truncated cylindrical shell 4 through which extends a common central axis. Clevises 3′ and 3″, as part of rings 4′ and 4″, force links 2′ and 2″ to ascend or descend as those devises approach or recede from the pinion gears in the rotations of their rings thereby causing output structure 1, supporting the object to be oriented, to rotate about at least two axes. Link 2 is not directly forced to move by a motor but is forced to move by movements of output structure 1 due to its rotary connection thereto and to base truncated cylindrical shell 4 provided the base of the present embodiment. As in the two previous embodiments, link 2 functions to stabilize the roll axis of the manipulator. Without this constraint, unwanted roll rotation of the object to be manipulated, that is, the workpiece, could result about axis 7.

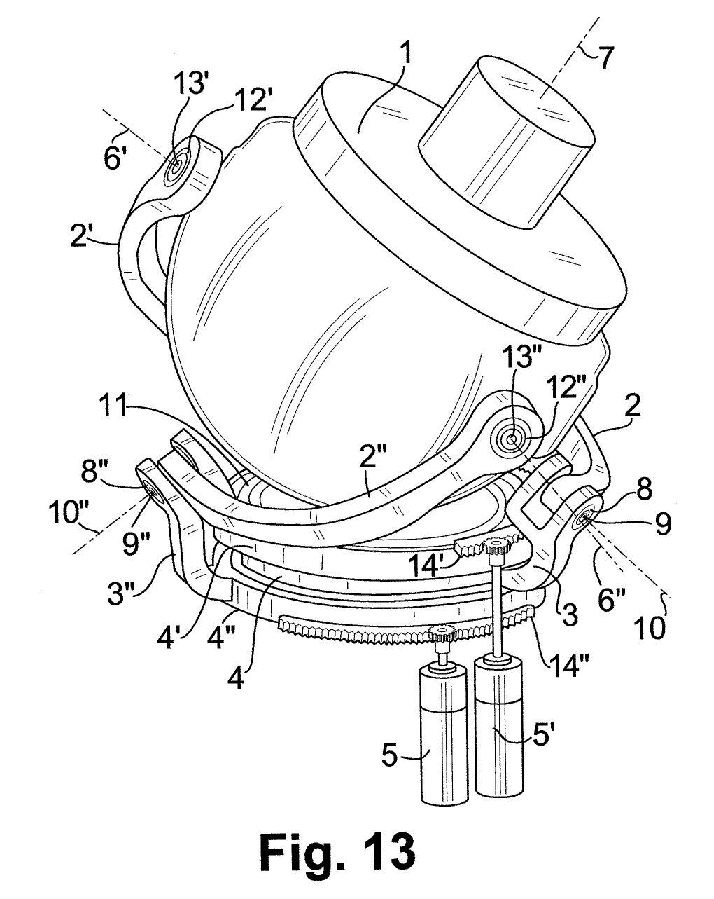

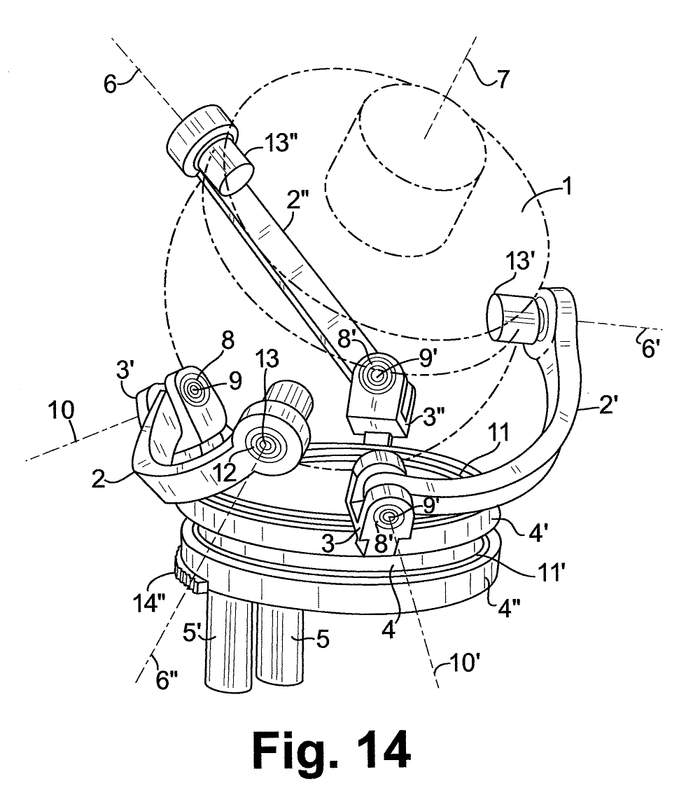

Operation of the device can best be seen in FIGS. 13 and 14. The object to be oriented is tilted by the rotations of the rotors of motors 5 and 5′. These motors in these figures have rotated one sector gear clockwise and the other sector gear counterclockwise through rotating the spur pinion gears to the point of reaching their extreme positions. By rotating the spur gear sectors, and thus the rings 4′ and 4″, the two devises 3′ and 3″ have been moved closer to one another and away from clevis 3. The result is clevis 3 has caused link 2 to move towards the motors bringing bearing 12, and so pivot pin 13, with it and thus lowering that side of output structure 1. Conversely, in FIG. 14, devises 3′ and 3″ have moved toward clevis 3 by rotating about bearings 11 and 11′ to lift link 2 with bearing 12, and thus pivot 13, to lift that side of output structure 1. By combinations or singular rotations of these motor rotors and the connected structure, any angular direction with respect to the original base plane may be achieved.

Links 2, 2′ and 2″, in addition to orienting a workpiece mounted in shell or output structure 4, can be arranged to aid in isolating that workpiece, typically some kind of a sensor, from shock and vibration which may otherwise be transmitted thereto from base 1 of the manipulator. Thus, the arrangements for link bearings 12, 12′ and 12″, clevis bearings 8, 8′ and 8″, and large shell ring bearings 11 and 11′, in this system may be shock mounted in rubber bushings or provided with other forms of shock and vibration dampening devices.

The different foregoing mechanical embodiments allow choosing different center points of rotation of mounted objects to be manipulated. As a result, one may be chosen over the others in a particular object orienting situation as being better suited to its surroundings in use.

Although the present invention has been described with reference to preferred embodiments, workers skilled in the art will recognize that changes may be made in form and detail without departing from the spirit and scope of the invention.

1. A controlled relative motion system permitting a controlled motion member, joined to a base member, to selectively move with respect to said base member, said system comprising:
a base support,
an output structure,
a plurality of securing links each rotatably connected at a first end thereof to a selected one of said base support and said output structure so as to be free to rotate about a corresponding intersection rotation axis that intersects that end, and with a circumferential motion pair of said securing links having each member thereof rotatably connected at an opposite second end thereof to that remaining one of said base support and said output structure so as to have said second end of each member rotate in a corresponding rotation plane, all of which rotation planes are parallel to one another, and also so as to rotate about a common symmetry rotation axis perpendicular to said rotation planes that is free of intersecting with any of said second ends, and
a force imparting member that is coupled to a selected coupling one of said first and second ends of a selected one of said circumferential motion pair of securing links, and is capable of directing said coupling end to rotate.

2. The apparatus of claim 1 wherein another of said securing links in said plurality thereof other than one of said circumferential motion pair of said securing links is connected at an opposite second end thereof to that remaining one of said base support and said output structure.

3. The apparatus of claim 1 wherein said force imparting member is a first force imparting member and further comprising a second force imparting member that is coupled to a selected coupling one of said first and second ends of that remaining one of said circumferential motion pair of securing links, and is capable of directing said coupling end of that remaining one of said circumferential motion pair of securing links to rotate.

4. The apparatus of claim 1 wherein said first ends of said circumferential motion pair of said securing links are each rotatably connected to said base support and said second ends thereof are each connected to a corresponding ring in said output structure with each said ring being rotatably connected at differing locations to an outer surface of a truncated cylindrical structure in said output structure and also being intersected at a circumferential surface thereof by a said rotation plane.

5. The apparatus of claim 4 wherein another of said securing links in said plurality thereof other than one of said circumferential motion pair of said securing links is connected at an opposite second end thereof to said truncated cylindrical structure.

6. The apparatus of claim 4 wherein said force imparting member is a first force imparting member and is coupled to a first end of said selected one of circumferential motion pair of said securing links, and further comprising a second force imparting member that is coupled to said first end of that remaining one of said circumferential motion pair of securing links which is capable of directing said first end of that remaining one of said circumferential motion pair of securing links to rotate.

7. The apparatus of claim 5 wherein said force imparting member is a first force imparting member and is coupled to a first end of said selected one of circumferential motion pair of said securing links, and further comprising a second force imparting member that is coupled to said first end of that remaining one of said circumferential motion pair of securing links which is capable of directing said first end of that remaining one of said circumferential motion pair of securing links to rotate.

8. The apparatus of claim 1 wherein said first ends of said circumferential motion pair of said securing links are each rotatably connected to said base support and said second ends thereof each have a spherical ball that is captured in a circumferential groove about a common ring in said output structure with said ring being intersected at a circumferential surface thereof by a said rotation plane common to each said second end.

9. The apparatus of claim 8 wherein another of said securing links in said plurality thereof other than one of said circumferential motion pair of said securing links is connected at an opposite second end thereof to said common ring.

10. The apparatus of claim 8 wherein said force imparting member is a first force imparting member and is coupled to a first end of said selected one of circumferential motion pair of said securing links, and further comprising a second force imparting member that is coupled to said first end of that remaining one of said circumferential motion pair of securing links which is capable of directing said first end of that remaining one of said circumferential motion pair of securing links to rotate.

11. The apparatus of claim 9 wherein said force imparting member is a first force imparting member and is coupled to a first end of said selected one of circumferential motion pair of said securing links, and further comprising a second force imparting member that is coupled to said first end of that remaining one of said circumferential motion pair of securing links which is capable of directing said first end of that remaining one of said circumferential motion pair of securing links to rotate.

12. The apparatus of claim 1 wherein said first ends of said circumferential motion pair of said securing links are each rotatably connected to said output structure and said second ends thereof are each connected to a corresponding ring in said base support with each said ring being rotatably connected at differing locations to an outer surface of a truncated cylindrical structure in said base support and also being intersected at a circumferential surface thereof by a said rotation plane.

13. The apparatus of claim 12 wherein another of said securing links in said plurality thereof other than one of said circumferential motion pair of said securing links is connected at an opposite second end thereof to said truncated cylindrical structure.

14. The apparatus of claim 12 wherein said force imparting member is a first force imparting member and is coupled to a second end of said selected one of circumferential motion pair of said securing links through said ring corresponding thereto, and further comprising a second force imparting member that is coupled to said second end of that remaining one of said circumferential motion pair of securing links through said ring corresponding thereto and which is capable of directing said second end of that remaining one of said circumferential motion pair of securing links to rotate.

15. The apparatus of claim 14 wherein said first and second force imparting members are electric motors having a motor gear affixed to an output shaft thereof, and each of said corresponding rings in said base support has a sector gear affixed thereto engaged with a corresponding said motor gear.

16. The apparatus of claim 13 wherein said force imparting member is a first force imparting member and is coupled to a second end of said selected one of circumferential motion pair of said securing links through said ring corresponding thereto, and further comprising a second force imparting member that is coupled to said second end of that remaining one of said circumferential motion pair of securing links through said ring corresponding thereto and which is capable of directing said second end of that remaining one of said circumferential motion pair of securing links to rotate.

17. The apparatus of claim 16 wherein said first and second force imparting members are electric motors having a motor gear affixed to an output shaft thereof, and each of said corresponding rings in said base support has a sector gear affixed thereto engaged with a corresponding said motor gear.
